(19) United States
(12) Patent Application Publication
(10) Pub. No.: US 2006/0140394 A1
(43) Pub. Date: Jun. 29, 2006

(54) Shrink wrap protection for portable wireless devices

(76) Inventor: Leo Kahl, Baltimore, MD (US)

Correspondence Address: SHLESINGER, ARKWRIGHT & GARVEY LLP, 3000 South Eads Street, Arlington, VA, 22202, US

(21) Appl. No.: 11/355,943

(22) Filed: Feb. 17, 2006

Related U.S. Application Data
(63) Continuation of application No. 10/652,551, filed on Sep. 2, 2003.
Application No. 10/652,551 is a continuation of application No. 09/656,268, filed on Sep. 6, 2000, now abandoned.

(51) Int. Cl. H04M 1/00

(52) U.S. Cl. 379/419

(57) ABSTRACT

A method for protecting a portable wireless device comprises providing a heat-shrinkable, light transmitting plastic bag; inserting the wireless device within the bag; heat shrinking the bag to intimately contact the outer surfaces of the wireless device with the interior surface of the bag. A protective bag for portable wireless device comprises a heat-shrinkable, light transmitting plastic bag adapted to receive completely therein in the portable wireless device, wherein the plastic bag is heat-shrunk to intimately contact the outer surfaces of the device with the interior surface of the bag.

### FIELD OF THE INVENTION

The present invention is directed to a device and method for protecting and personalizing a portable wireless device.

### BACKGROUND OF THE INVENTION

Portable wireless devices, such as cellular phones, are increasingly popular today for their convenience and the sense of security they give in case of an emergency. It is common today to see someone walking along while using a cellular phone, a driver operating a vehicle with a cellular phone stuck to the driver's ear, or someone on vacation with a cellular phone next to his drink. With their widespread use, it would not be unexpected that these devices would get a lot of abuse, such as getting exposed to rain, getting their screens scratched up inside a purse or pocket, or accidentally getting picked up by mistake while laying out on a counter.

There is, therefore, a need for a device to make these wireless devices more resistant to the weather, such as light rain, provide scratch protection to their LCD screens and to make them more distinguishable from other similar devices.

### OBJECTS AND SUMMARY OF THE INVENTION

It is an object of the present invention to provide a device and method for protecting portable wireless devices from moisture, such light rain, snow, water spills, etc.

It is another object of the present invention to provide a device and method for protecting the exterior surfaces of portable wireless devices from being scratched, especially their LCD screens, while they are carried around inside the users' pockets, purses, glove compartments, etc.

It is still another object of the present invention to provide a device and method for personalizing a portable wireless device so that it is readily distinguishable from other similar devices and thereby lessen its chance of being picked up by mistake by someone thinking it was his own.

In summary, the present invention provides a method for protecting a portable wireless device comprising providing a heat-shrinkable, light transmitting plastic bag; inserting the wireless device within the bag; and heat shrinking the bag to intimately contact the outer surfaces of the wireless device with the interior surface of the bag.

The present invention also provides a protective bag for a portable wireless device, comprising a heat-shrinkable, light transmitting plastic bag adapted to receive completely therein in the portable wireless device, wherein the plastic bag is heat-shrunk to intimately contact the outer surfaces of the device with the interior surface of the bag.

These and other objects of the present invention will become apparent from the following detailed description.

### BRIEF DESCRIPTIONS OF THE DRAWINGS

FIG. 1 is a front perspective view of a cellular phone using the device of the present invention.

FIG. 2 is a perspective view of a cellular phone using the device of the present invention having indicia thereon.

FIG. 3 is a cross-sectional view taken along line 3-3 of FIG. 1.

FIG. 4A is a perspective view of a clear plastic shrink wrap bag about to receive within it a cellular phone.

FIG. 4B is a fragmentary perspective view of another embodiment of the bag of FIG. 4A, showing an enclosure for the device's antenna.

FIG. 5 is a perspective view of the bag of FIG. 4A in the process of enclosing the cellular phone.

FIG. 6 is a perspective view of the bag of FIG. 4A with the cellular phone within it and being shrunk with a heat source.

### DETAILED DESCRIPTION OF THE INVENTION

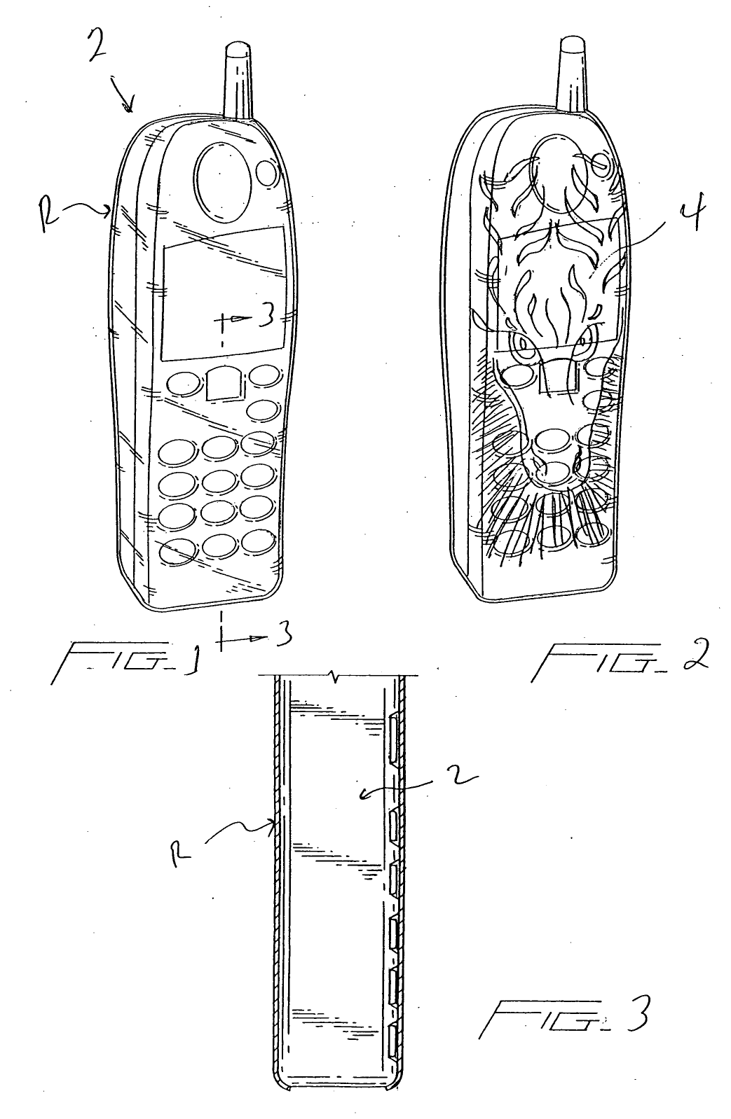

A portable wireless device, such as a cellular phones 2, using a protective device R made in accordance with the present invention is disclosed in FIG. 1. The device R is made of a clear or light transmitting plastic material, such as PVC or polyolephin, which has been heat-shrunk to conform to the outer shape of the cellular phone 2. The material is light transmitting to allow the user to clearly see the keypad and screen of the phone. The plastic material is moisture resistant, thereby affording the cellular phone protection from exposure to moisture, such as when used in a light rain, snow, etc. The device R provides a replaceable wearing surface to protect the outer surfaces of the phone from scratches, particularly to the LCD screen, to keep the device looking new longer.

Referring to FIG. 2, the device R may be imprinted with an indicia 4, such as the shape of an animal head, to provide a distinguishing mark to the cellular phone from other similar phones. The indicia 4 may take the form of any design. The indicia is printed with see-through color so that it does not obscure the keypad and function buttons on the face of the phone. The device R may also be made with a see-through iridescent color. With the indicia 4, one's phone can become uniquely personalized.

Referring to FIG. 3, the device R is shown in intimate contact with the exterior surfaces of the cellular phones 2 so that it stays secured to the phone. The device R does not cover the bottom part of the cellular phone to leave the contact points normally found there exposed for access.

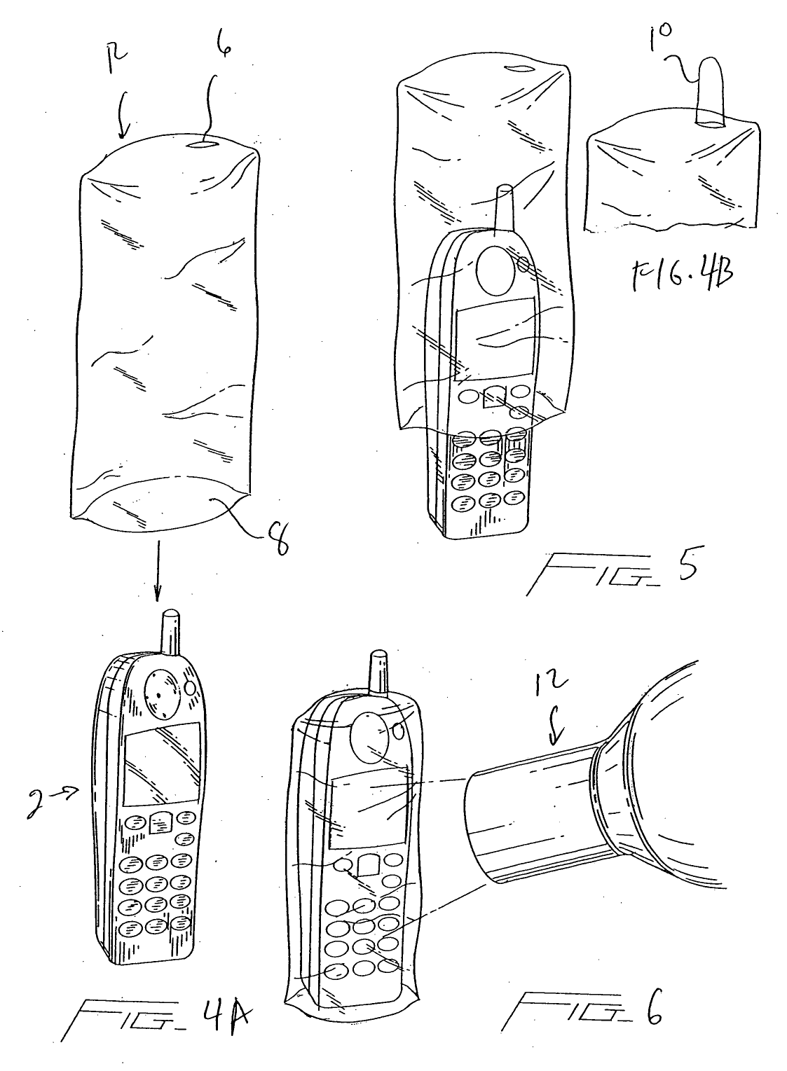

Referring to FIG. 4, the device R is in the form of a transparent bag sized to fit the cellular phone 2. The size is preferably very close to the actual phone size, just big enough to slip the phone inside the bag. An opening 6 is provided at the top of the bag to allow the antenna of the cellular phone to protrude through the bag. Except for the opening 6, the top of the bag is enclosed. The bottom of the bag has an opening 8 to allow the bag to receive the cellular phone. Alternatively, the opening 6 may be provided with an extension 10 adapted to receive and enclose the antenna when the bag is slipped around the cellular phone.

After the bag has been positioned around the cellular phone, a heat source, such as a hair blow dryer 12, is directed at the bag, shrinking the bag to make a tight intimate contact with the outer surfaces of the cellular phone, as best shown in FIG. 6. The bag conforms to the overall outer shape of the phone. The contacts at the bottom of the phone remain accessible by means of the opening 8 at the bottom of the bag.

With the use of the device R, the cellular phone is provided with a protective covering to provide protection against moisture and from being scratched when carried around. In addition, with the use of an indicia 4, the cellular phone can be personalized, allowing for easy identification of the device from other identical units.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

1. A method for protecting a portable wireless device, comprising:
a) providing a heat-shrinkable, light transmitting plastic bag;
b) inserting the wireless device within the bag; and
c) heat shrinking the bag to intimately contact the outer surfaces of the wireless device with the interior surface of the bag.

2. A method as in claim 1, wherein:
a) said bag includes indicia made from light-transmitting ink.

3. A method as in claim 1, wherein:
a) said bag is made with iridescent light transmitting color.

4. A portable wireless device, comprising:
a) a plastic layer disposed over the outer surfaces of said device, said plastic layer being formed from a heat-shrinkable, light transmitting plastic bag adapted to receive completely therein said device and then heat-shrinking said bag.

5. A portable wireless device as in claim 4, wherein:
a) said bag includes indicia made from light-transmitting ink.

6. A portable wireless device as in claim 4, wherein:
a) said bag is made with iridescent light transmitting color.

7. A protective bag for a portable wireless device, comprising:
a) a heat-shrinkable, light transmitting plastic bag, adapted to receive completely therein the portable wireless device, wherein said plastic bag is heat-shrunk to intimately contact the outer surfaces of the device with the interior surface of said bag.

8. A protective bag as in claim 7, wherein:
a) said bag includes a graphic indicia.

9. A protective bag as in claim 7, wherein:
a) said bag is made with iridescent color.
